(19) United States
(12) Patent Application Publication
(10) Pub. No.: US 2024/0073479 A1
(43) Pub. Date: Feb. 29, 2024

(54) VIDEO TRANSMISSION SYSTEM AND METHOD

(71) Applicant: KABUSHIKI KAISHA TOSHIBA, Tokyo (JP)

(72) Inventor: Ichiro TOMODA, Hamura (JP)

(73) Assignee: KABUSHIKI KAISHA TOSHIBA, Tokyo (JP)

(21) Appl. No.: 18/177,801

(22) Filed: Mar. 3, 2023

(30) Foreign Application Priority Data
Aug. 25, 2022 (JP) 2022-134144

(51) Int. Cl. H04N 21/4363; H04N 21/654

(52) U.S. Cl. CPC H04N 21/43635; H04N 21/654

(57) ABSTRACT

According to one embodiment, a sink device includes a first transmitter transmitting first identification information for identifying the sink device to a first server device constructing a digital twin of the sink device, a first receiver receiving first connection information created based on the first identification information, and a second transmitter transmitting the first connection information to the source device via a HDMI cable. A source device includes a third transmitter transmitting the first connection information to a second server device constructing a digital twin of the source device. The first connection information is used to establish a connection between the first server device and the second server device.

### CROSS-REFERENCE TO RELATED APPLICATIONS

This application is based upon and claims the benefit of priority from Japanese Patent Application No. 2022-134144, filed Aug. 25, 2022, the entire contents of which are incorporated herein by reference.

### FIELD

Embodiments described herein relate generally to a video transmission system and a method.

### BACKGROUND

In general, HDMI (registered trademark) cables are widely used. By using such HDMI, a video transmission system in which a source device that transmits video data and a sink device that receives and displays the video data are connected by an HDMI cable can be easily used.

In recent years, a technology that is referred to as “digital twin” has become known, which reproduces a physical space in a cyber space by collecting data (information) of the physical space.

By applying this digital twin to the video transmission system described above, it may be possible to provide more useful services to the users of the video transmission system and improve the convenience of the users.

### BRIEF DESCRIPTION OF THE DRAWINGS

FIG. 1 shows an example of a configuration of a network system in an embodiment.

FIG. 2 illustrates a configuration of a video transmission system.

FIG. 3 illustrates an overview of a digital twin.

FIG. 4 illustrates a relationship between the video transmission system and the digital twin.

FIG. 5 is a sequence chart for explaining an overview of processing executed in the video transmission system, a server device for a source, and a server device for a sink.

FIG. 6 illustrates a specific operation example of the video transmission system, the server device for a source, and the server device for a sink.

FIG. 7 shows an example of a DTL data structure.

FIG. 8 shows a data structure of VSDB data.

FIG. 9 illustrates a first modified example of the present embodiment.

FIG. 10 shows a data structure of VSIF data.

FIG. 11 illustrates a second modified example of the present embodiment.

FIG. 12 illustrates the second modified example of the present embodiment.

### DETAILED DESCRIPTION

In general, according to one embodiment, a video transmission system includes a source device transmitting video data, a sink device receiving the video data, and an HDMI cable connecting the source device and the sink device. The sink device includes a first transmitter transmitting first identification information for identifying the sink device to a first server device constructing a digital twin of the sink device, a first receiver receiving first connection information with respect to the first server device created by the first server device based on the first identification information, and a second transmitter transmitting the received first connection information to the source device via the HDMI cable. The source device includes a third transmitter transmitting the first connection information transmitted by the second transmitter to a second server device constructing a digital twin of the source device. The first connection information transmitted by the third transmitter is used to establish a connection between the first server device and the second server device.

Various embodiments will be described with reference to the accompanying drawings.

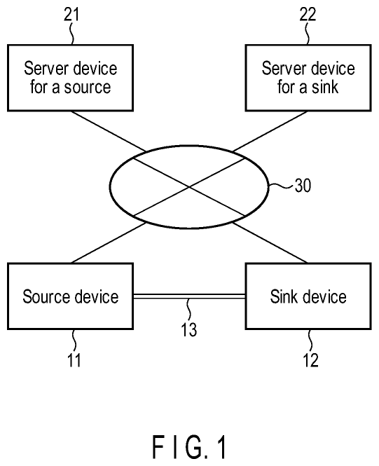

FIG. 1 shows an example of a configuration of a network system in the present embodiment. The network system shown in FIG. 1 includes a source device 11, a sink device 12, a server device 21 for a source, and a server device 22 for a sink. Note that, in the present embodiment, the source device 11 and the sink device 12 are connected via a high-definition multimedia interface (HDMI) cable 13.

The source device 11 corresponds to a transmitting device that transmits video data to the sink device 12 via the HDMI cable 13 described above. The source device 11 includes, for example, a recorder, an optical disc player, a set-top box, a video camera, a personal computer, and a smartphone.

The sink device 12 corresponds to a receiving device that receives video data transmitted from the source device 11 via the HDMI cable 13. The sink device 12 includes, for example, a TV (television receiver), a monitor, a projector, a personal computer, a smartphone, and a digital signage.

In the present embodiment, the video data is mainly described as being transmitted from the source device 11 to the sink device 12 for convenience; however, the video data and audio data may also be transmitted from the source device 11 to the sink device 12.

Note that the source device 11 has a communication function and is communicatively connected to the server device 21 for a source via a network 30 such as the Internet. Similarly, the sink device 12 has a communication function and is communicatively connected to the server device 22 for a sink via the network 30, for example.

In the present embodiment, the above source device 11, sink device 12, and HDMI cable 13 configure a video transmission system.

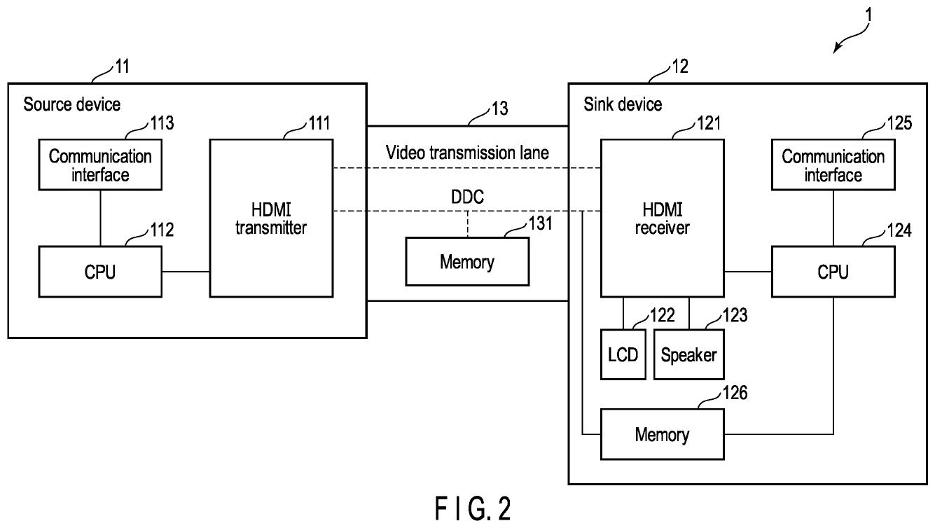

Next, the configuration of the video transmission system of the present embodiment will be described with reference to FIG. 2. As shown in FIG. 2, a video transmission system 1 includes the source device 11, the sink device 12, and the HDMI cable 13.

The source device 11 includes an HDMI transmitter 111, a CPU 112, and a communication interface 113.

The HDMI transmitter 111 transmits video data to the sink device 12 by a transition minimized differential signaling (TMDS) method using a video transmission lane of the HDMI cable 13, for example.

The HDMI transmitter 111 uses a display data channel (DDC) of the HDMI cable 13 to obtain data indicating the capability of the sink device 12 relating to video transmission. Specifically, the HDMI transmitter 111 obtains extended display information data (EDID) from the sink device 12 as data indicating the capability of the sink device 12 relating to video transmission. The EDID is configured by data indicating the functions and performance supported by the sink device 12 based on a format defined in the CTA-861 standard.

The HDMI transmitter 111 also obtains data indicating capabilities related to video transmission of the HDMI cable 13 (hereinafter referred to as cable data) from the HDMI cable 13 using, for example, the DDC of the HDMI cable 13. This cable data is configured by a cable ID (identification information for identifying the HDMI cable 13) including a manufacturer name (vendor ID), a product model number (type of HDMI cable 13), and a serial number of the HDMI cable 13, and data indicating the functions and performance supported by the HDMI cable 13.

The CPU 112 is a processor for controlling the operation of components in the source device 11, including the HDMI transmitter 111.

The communication interface 113 is a module for enabling communication with the server device 21 for a source described above.

The sink device 12 includes an HDMI receiver 121, a liquid crystal display (LCD) 122, a speaker 123, a CPU 124, a communication interface 125, and a memory 126.

The HDMI receiver 121 receives video data transmitted from the source device 11 and displays the video data on the LCD 122. In addition, in a case where audio data is transmitted from the source device 11, the HDMI receiver 121 receives the audio data and causes the audio data to be output from the speaker 123.

The CPU 124 is a processor for controlling the operation of the components in the sink device 12, including the HDMI receiver 121.

The communication interface 125 is a module for enabling communication with the server device 22 for a sink described above.

The memory 126 stores the EDID and the sink device ID (identification information for identifying the sink device 12), etc., described above. The sink device ID includes, for example, a manufacturer name (vendor ID), a product model number (type of sink device 12), and a serial number of the sink device 12.

The HDMI cable 13 includes a memory 131. The memory 131 is a nonvolatile memory, and the cable data, etc., described above is stored in the memory 131.

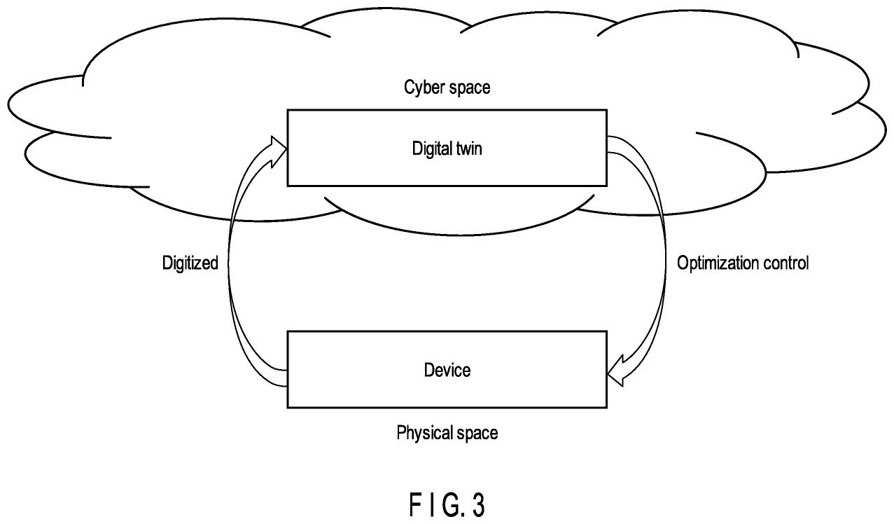

Here, there is a technology referred to as a digital twin that can reproduce a physical space in a cyber space based on data collected from the physical space. According to such a digital twin, for example, as shown in FIG. 3, (the state of) a device digitized based on data collected from a device arranged in a physical space can be reproduced in real time in a cyber space (in other words, a digital twin of the device is constructed), and the digital twin can be used to perform optimization control of the device arranged in the physical space.

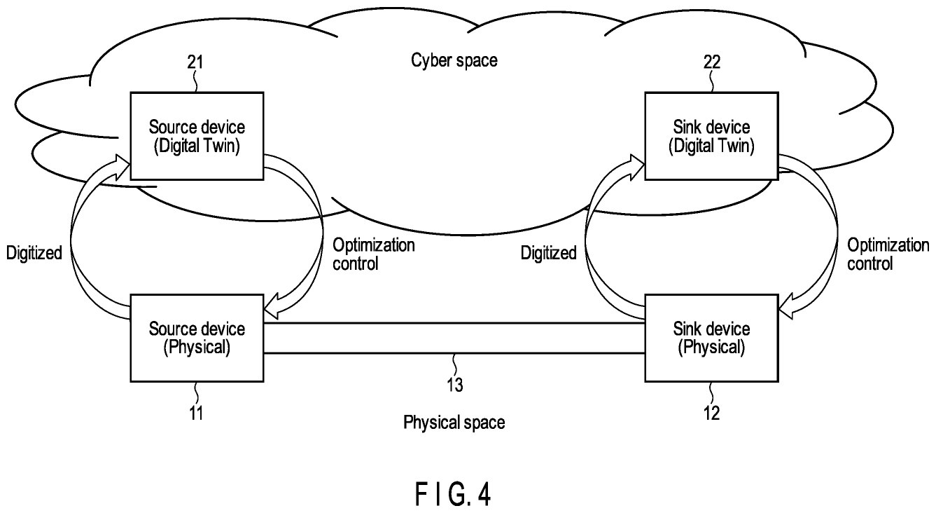

In the present embodiment, the digital twin described above is considered to be applied to the video transmission system 1. Specifically, the server device 21 for a source, which is communicatively connected to the source device 11, is configured to have a function of collecting various data related to the source device 11 from the source device 11 and constructing the digital twin of the source device 11 based on the data. In this case, as shown in FIG. 4, the server device 21 for a source can utilize the constructed digital twin of the source device 11 to capture the state of the source device 11 in real time and perform optimization control of the source device 11.

Similarly, the server device 22 for a sink, which is communicatively connected to the sink device 12, is configured to have a function of collecting various data related to the sink device 12 from the sink device 12 and constructing the digital twin of the sink device 12 based on the data. In this case, as shown in FIG. 4, the server device 22 for a sink can utilize the digital twin of the sink device 12 to capture the state of the sink device 12 in real time and perform optimization control of the sink device 12.

However, although the server device 21 for a source can construct the digital twin of the source device 11, it is not aware that the source device 11 is connected to the sink device 12 via the HDMI cable 13, and can only capture the state of the source device 11 alone. Similarly, although the server device 22 for a sink can construct the digital twin of the sink device 12, it is not aware that the sink device 12 is connected to the source device 11 via the HDMI cable 13, and can only capture the state of the sink device 12 alone.

In other words, if the server device 21 for a source and the server device 22 for a sink only construct digital twins individually as described above, it is not possible to properly capture the state of the entire video transmission system 1, and it is not necessarily possible to provide a useful service to the user.

Therefore, the present embodiment provides a mechanism that can construct a digital twin of the video transmission system 1 including the source device 11 and the sink device 12 when the source device 11 is connected to the sink device 12 via the HDMI cable 13.

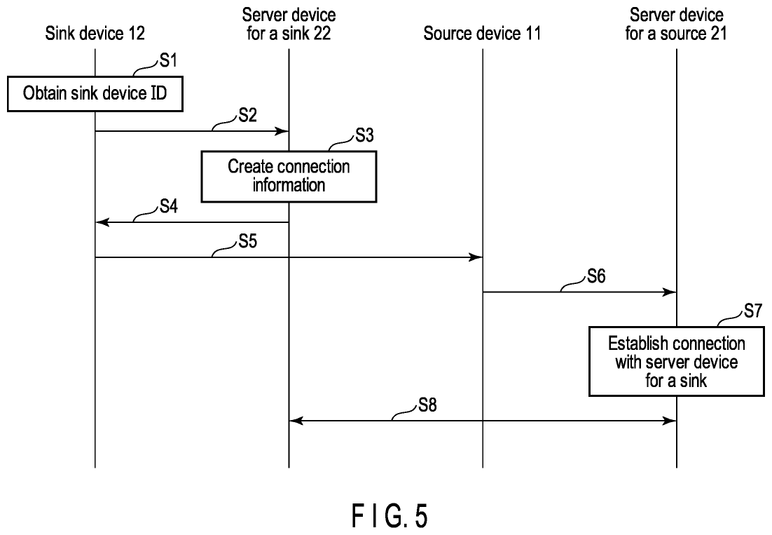

In the following, with reference to a sequence chart in FIG. 5, an overview of processing executed in the video transmission system 1 (the source device 11 and the sink device 12), the server device 21 for a source, and the server device 22 for a sink will be described.

The processing shown in FIG. 5 can be executed, for example, at a timing when the source device 11 and the sink device 12 are connected via the HDMI cable 13; however, may also be executed at a timing specified by the user of the video transmission system 1 or at a preset timing.

In addition, as mentioned above, the server device 21 for a source is considered to have a function of collecting data related to the source device 11 and constructing a digital twin of the source device 11. In addition, the server device 22 for a sink is considered to have a function of collecting data related to the sink device 12 and constructing a digital twin of the sink device 12.

In addition, the source device 11 and the sink device 12 are considered to be connected via the HDMI cable 13. However, the server device 21 for a source that is communicatively connected to the source device 11 and the server device 22 for a sink that is communicatively connected to the sink device 12 are not aware that the source device 11 and the sink device 12 are connected via the HDMI cable 13, and are each considered as operating independently.

Note that the processing of the source device 11 described below is considered to be realized by operation of a processor such as the CPU 112 provided in the source device 11, and the processing of the sink device 12 is considered to be realized by operation of a processor such as the CPU 124 provided in the sink device 12. Note that the processing of the server device 21 for a source and the server device 22 for a sink is also considered to be realized by operations of processors such as CPUs provided in the server device 21 for a source and the server device 22 for a sink.

In the case of constructing the digital twin of the video transmission system 1 as described above, the sink device 12 (CPU 124) obtains, for example, a sink device ID from the memory 126 provided in the sink device 12 (step S1).

After the processing of step S1 is executed, the sink device 12 transmits the sink device ID obtained in step S1 to the server device 22 for a sink (step S2).

The server device 22 for a sink receives the sink device ID transmitted in step S2 and creates connection information with respect to the server device 22 for a sink (connection information used to establish a connection to the server device 22 for a sink) based on the sink device ID (step S3).

The connection information created in step S3 is transmitted from the server device 22 for a sink to the sink device 12 (step S4).

The sink device 12 receives the connection information transmitted in step S4 and transmits the connection information to the source device 11 via the HDMI cable 13 (step S5).

Next, the source device 11 receives the connection information transmitted in step S5 and transmits the connection information to the server device 21 for a source (step S6).

After the processing of step S6 is executed, the server device 21 for a source receives the connection information transmitted in step S6, and establishes a connection between the server device 21 for a source and the server device 22 for a sink using the connection information (step S8).

According to the processing shown in FIG. 5 above, the connection between the server device 21 for a source and the server device 22 for a sink is established by the connection information with respect to the server device 22 for a sink created based on the sink device ID being given to the server device 21 for a source via the sink device 12, the HDMI cable 13, and the source device 11 (i.e., through a connection in physical space). In this case, the server device 21 for a source and the server device 22 for a sink can operate in cooperation, thereby enabling the digital twin of the video transmission system 1 including the source device 11 and the sink device 12 to be constructed.

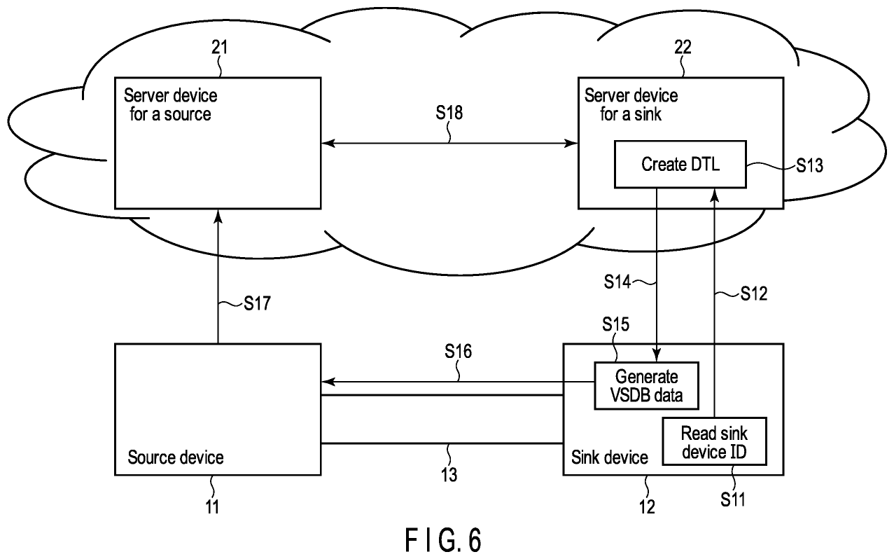

Next, with reference to FIG. 6, a specific operation example of the video transmission system 1, the server device 21 for a source, and the server device 22 for a sink will be described.

Here, the sink device ID and EDID for identifying the sink device 12 are written in the memory 126 (e.g., ROM) provided in the sink device 12. Note that the sink device ID should be written in the memory 126 at the time of shipment of the sink device 12.

In this case, the sink device 12 reads the sink device ID from the memory 126 (step S11).

Next, the sink device 12 transmits the sink device ID read from the memory 126 to the server device 22 for a sink (digital twin of the sink device 12) (step S12).

The server device 22 for a sink uses the sink device ID transmitted from the sink device 12 to create an identifier referred to as a digital twin locator (DTL) to identify the server device 22 for a sink (i.e., the digital twin of the sink device 12) (step S13). This DTL (hereinafter referred to as a DTL of the sink digital twin) corresponds to the connection information with respect to the server device 22 for a sink described above.

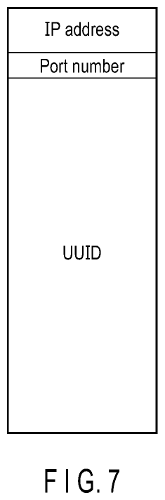

In this case, the server device 22 for a sink creates a DTL of the sink digital twin having a data structure as shown in FIG. 7, for example.

Specifically, the DTL of the sink digital twin is configured by three elements of an IP address, a port number, and a universally unique identifier (UUID).

The IP address that configures the DTL of the sink digital twin is an IP address assigned to the server device 22 for a sink. Also, the port number that configures the DTL of the sink digital twin is a connection destination port number when TCP/IP connection is made to the server device 22 for a sink. The IP address and the port number necessary to create the DTL of the sink digital twin are considered to be managed in advance in the server device 22 for a sink.

In addition, the UUID that configures the DTL of the sink digital twin corresponds to an ID number for identifying the digital twin of the sink device 12 constructed by the server device 22 for a sink, and is uniquely assigned to the sink device 12. The UUID is generated by combining, for example, the IEEE MAC address of the host generating the UUID (e.g., the server device 22 for a sink) and the time (in nanoseconds) of generating the UUID according to, for example, specifications defined in IETF RFC 4122. Note that there are several versions of the UUID format; however, in the present embodiment, for example, a case in which Version1 is used is assumed.

In the present embodiment, the server device 22 for a sink prepares in advance a table that maintains the correspondence between the above-mentioned sink device ID and the UUID assigned to the sink device 12, so that the UUID necessary to create the DTL of the sink digital twin (that is, the UUID corresponding to the sink device ID transmitted from the sink device 12) can be obtained from the table.

Note that, here, although the sink device ID including a vendor ID, a product model number, and a serial number is described as being transmitted from the sink device 12 to the server device 22 for a sink, the sink device ID transmitted from the sink device 12 to the server device 22 for a sink may include only the serial number, for example. The vendor ID and the product model number may be obtained (received) from an external device of the video transmission system 1. In addition, although the above-described UUID is assumed to be generated in the server device 22 for a sink, it may be generated in an external device different from the server device 22 for a sink.

Next, the server device 22 for a sink transmits the created DTL of the sink digital twin to the sink device 12 (step S14).

Here, the sink device 12 needs to pass the DTL of the sink digital twin transmitted from the server device 22 for a sink to the source device 11 via the HDMI cable 13. In this case, in the present embodiment, a VSDB/VSIF mechanism is considered to be used. Note that the VSDB/VSIF is a data format for exchanging control information compliant with the HDMI standard between the source device 11 and the sink device 12. A vendor-specific data block (VSDB) is used when transmitting the control information from the sink device 12 to the source device 11, and a vendor-specific InfoFrame (VSIF) is used when transmitting the control information from the source device 11 to the sink device 12.

That is, in the case of transmitting the DTL of the sink digital twin from the sink device 12 to the source device 11 as described above, the sink device 12 generates data (hereinafter referred to as VSDB data) by adding (inserting) the DTL to a VSDB compliant data structure (step S15).

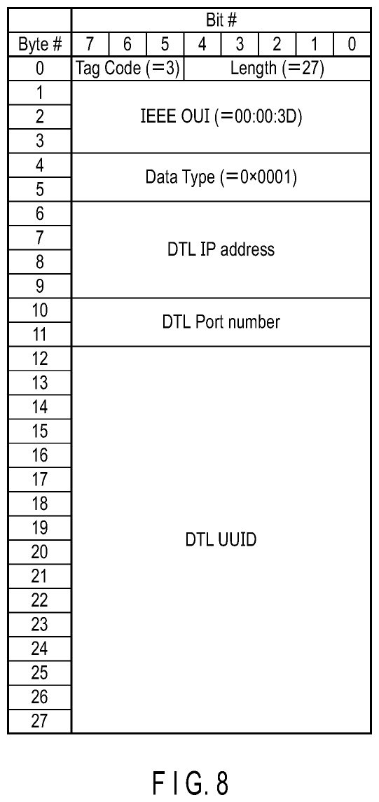

Here, FIG. 8 shows the data structure of the VSDB data (VSDB data format). Note that, in FIG. 8, the VSDB data with a size of byte 0 to byte 27 is assumed.

As shown in FIG. 8, a Tag Code is arranged in the upper three bits of byte 0 of the VSDB data, and the Tag Code represents the type of data block. Note that, according to the HDMI standard, the Tag Code representing the VSDB is defined as “3”.

Length is arranged in the lower five bits of byte 0 of the VSDB data, and the Length represents the size (number of bytes) of the payload (the portion thereafter the IEEE OUI) of the VSDB data. In the example shown in FIG. 8, the Length is “27”.

The IEEE OUI is arranged in bytes 1 to 3 of the VSDB data, and the IEEE OUI represents a 3-byte number (OUI issued by the IEEE) to identify a VSDB vendor. In the example shown in FIG. 8, the IEEE OUI is “00:00:3D”.

In addition, Data Type is arranged in byte 4 and byte 5 of the VSDB data, and the Data Type is a number (16-bit integer) representing the type of data arranged thereafter byte 6. In the example shown in FIG. 8, the Data Type is “0x0001”, which represents the DTL of the sink digital twin.

In addition, the DTL of the sink digital twin is arranged (inserted) thereafter byte 6 of the VSDB data. The DTL of the sink digital twin is configured by the IP address (4 bytes), the port number (2 bytes), and the UUID (16 bytes) as described above.

Returning to FIG. 6 again, the sink device 12 adds the above VSDB data to the EDID and transmits the EDID to the source device 11 via the HDMI cable 13 (step S16). In this case, the EDID is transmitted according to the DDC, which is a protocol for exchanging control information compliant with the HDMI standard.

The source device 11 receives the EDID transmitted from the sink device 12. The source device 11 extracts the VSDB data from the received EDID, extracts the DTL of the sink digital twin from the VSDB data, and transmits the DTL to the server device 21 for a source (step S17).

The server device 21 for a source receives the DTL of the sink digital twin transmitted from the source device 11 and establishes a connection with the server device 22 for a sink based on the IP address and the port number configuring the received DTL of the sink digital twin (step S18). Thereby, the server device 21 for a source can capture that the source device 11 and the sink device 12 to which the UUID that configures the DTL of the sink digital twin is assigned (that is, the sink device 12 identified by the sink device ID corresponding to the UUID) are connected via the HDMI cable 13.

As described above, in the present embodiment, the sink device 12 transmits the sink device ID (first identification information) for identifying the sink device 12 to the server device 22 for a sink (first server device) that constructs the digital twin of the sink device 12, receives from the server device 22 for a sink the DTL (first connection information) of the sink digital twin created in the server device 22 for a sink based on the sink device ID, and transmits such a DTL to the source device 11 via the HDMI cable 13. In addition, in the present embodiment, the source device 11 transmits the DTL of the sink digital twin transmitted from the sink device 12 to the server device 21 for a source (second server device) that constructs the digital twin of the source device 11. The DTL transmitted from the source device 11 to the server device 21 for a source in this manner is used to establish a connection between the server device 21 for a source and the server device 22 for a sink.

In the case where the connection between the server device 21 for a source and the server device 22 for a sink is established as described above, the server device 21 for a source and the server device 22 for a sink can operate in cooperation. In this case, by sharing the data related to the source device 11 collected from the source device 11 and the data related to the sink device 12 collected from the sink device 12 between the server device 21 for a source and the server device 22 for a sink, the data can be used to construct a digital twin of the video transmission system 1 (a digital twin obtained by combining the digital twin of the source device 11 and the digital twin of the sink device 12).

Note that the DTL of the sink digital twin described above is inserted into the VSDB data having a VSDB compliant data structure and transmitted from the sink device 12 to the source device 11 via the HDMI cable 13. This VSDB data is also transmitted according to the DDC. That is, in the present embodiment, focusing on the high extensibility of the VSDB/VSIF, the DTL of the source digital twin can be passed from the sink device 12 to the source device 11 by using the extension function of the VSDB/VSIF.

In the present embodiment, as described above, the configuration of transmitting the DTL of the sink digital twin obtained from the server device 22 for a sink (i.e., the digital twin of the sink device 12 in the virtual space) on the VSDB over a physical connection allows the connection of the server device 21 for a source and the server device 22 for a sink to be established, and the digital twin of the video transmission system 1 to be constructed.

Note that such a digital twin of the video transmission system 1 may be constructed, for example, in each of the server device 21 for a source and the server device 22 for a sink. The digital twin of the video transmission system 1 may also be constructed in one of the server device 21 for a source and the server device 22 for a sink, and may be shared with the other server device.

In addition, as described above, data related to the source device 11 is considered to be continuously collected by the server device 21 for a source, data related to the sink device 12 is considered to be continuously collected by the server device 22 for a sink, and the data is considered to be reflected in the digital twin of the video transmission system 1 constructed as described above in real time. According to this, for example, since the state of the video transmission system 1 (the source device 11 and the sink device 12) can be captured in real time, various services using the digital twin of the video transmission system 1 can be provided to the users using the video transmission system 1.

The following is a brief description of an example of services (hereinafter referred to as provided services) provided using the digital twin of the video transmission system 1 constructed in the present embodiment. Here, as an example of a provided service, customer support service for the source device 11 (or the sink device 12), for example, will be described.

Generally, for example, in a case where the video transmission system 1 cannot be properly used, in some cases, the user of the video transmission system 1 may inquire about the use of the video transmission system 1 to a customer support center of the source device 11 (e.g., recorder). In this case, for example, if the digital twin of the source device 11 is to be constructed in the server device 21 for a source, an operator of the customer support center of the source device 11 can capture the state of the source device 11 in real time based on the digital twin of the source device 11 and support the user of the source device 11. However, in a case where there is a problem (malfunction) in the use of the sink device 12 (e.g., TV) instead of the source device 11, since the operator of the customer support center of the source device 11 cannot capture the state of the sink device 12, the operator of the customer support center of the sink device 12 will prompt the user to contact the customer support center of the sink device 12. In this case, the user needs to contact another customer support center again, which is inconvenient.

In contrast, according to the present embodiment, since it is possible to construct a digital twin of the video transmission system 1 including the source device 11 and the sink device 12 in the server device 21 for a source, for example, as described above, the operator of the customer support center of the source device 11 can support the user of the video transmission system 1 by capturing the state of the sink device 12 in addition to the source device 11.

That is, according to the present embodiment, the digital twin of the video transmission system 1 can be used to synthesize information possessed by a plurality of vendors (manufacturers of the source device 11 and the sink device 12) and provide HDMI support. Therefore, since the user does not have to go through the complicated process of contacting the customer support center of the sink device 12 after contacting the customer support center of the source device 11 as described above, it is considered that the convenience of the user can be improved.

By the way, in the present embodiment, the connection information (DTL of the sink digital twin) created in the server device 22 for a sink is described as being transmitted (transferred) to the server device 21 for a source via the sink device 12, the HDMI cable 13, and the source device 11. However, as long as a connection between the server device 21 of a source and the server device 22 of a sink can be established (that is, the digital twin of the video transmission system 1 is constructed), it may be a configuration (hereinafter referred to as a first modified example of the present embodiment) in which the connection information created in the server device 21 for a source (hereinafter referred to as the DTL of the source digital twin) is transmitted (transferred) to the server device 22 for a sink via the source device 11, the HDMI cable 13, and the sink device 12.

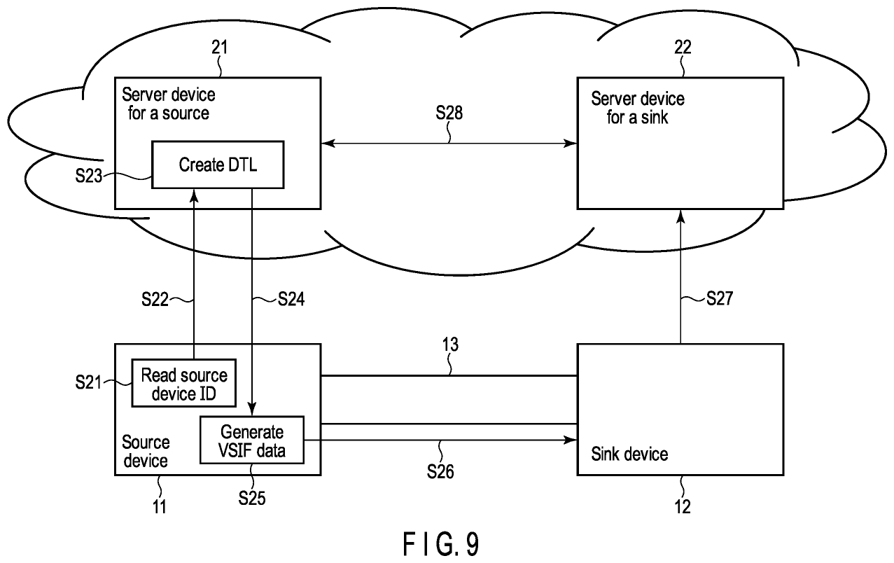

In the following, with reference to FIG. 9, a specific operation example of the video transmission system 1, the server device 21 for a source, and the server device 22 for a sink according to the first modified example of the present embodiment will be described.

Here, although omitted in FIG. 2 described above, it is considered that the source device 11 includes a memory (e.g., ROM), and that identification information for identifying the source device 11 (hereinafter referred to as a source device ID) is written in the memory. Note that the source device ID should be written in the memory at the time of shipment of the source device 11.

In this case, the source device 11 reads the source device ID from the memory (step S21). Note that the source device ID read from the memory includes a vendor ID (manufacturer name), a product model number (type of source device 11), and a serial number of the source device 11.

Next, the source device 11 transmits the source device ID read from the memory to the server device 21 for a source (digital twin of the source device 11) (step S22).

The server device 21 for a source uses the source device ID transmitted from the source device 11 to create a DTL to identify the server device 21 for a source (i.e., the digital twin of the source device 11) (step S23). This DTL (hereinafter referred to as the DTL of the source digital twin) corresponds to the connection information with respect to the server device 21 for a source.

Note that the DTL of the source digital twin is the same as the DTL of the sink digital twin described above, except that the source device ID is used instead of the sink device ID. Therefore, a detailed description thereof will be omitted here. Note that, in order to create the DTL of the source digital twin, the server device 21 for a source is considered to prepare in advance a table that maintains the correspondence between the source device ID and the UUID assigned to the source device 11.

Next, the server device 21 for a source transmits the created DTL of the source digital twin to the source device 11 (step S24).

Here, the source device 11 needs to pass the DTL of the source digital twin transmitted from the server device 21 for a source to the sink device 12 via the HDMI cable 13. In this case, the source device 11 generates data (hereinafter referred to as VSIF data) by adding (inserting) the DTL to a VSIF compliant data structure used in transmitting control information from the source device 11 to the sink device 12 as described above (step S25).

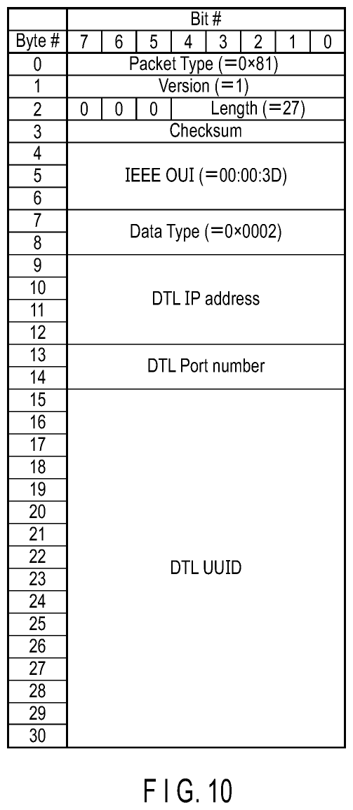

Here, FIG. 10 shows a data structure of the VSIF data (VSIF data format). Note that, in FIG. 10, VSIF data with a size of byte 0 to byte 30 is assumed.

As shown in FIG. 10, Packet Type is arranged in byte 0 of the VSIF data, and the Packet Type represents the type of InfoFrame. Note that, according to the HDMI standard, the Packet Type representing VSIF is defined as “0x81”.

In addition, Version is arranged in byte 1 of the VSIF data, and the Version represents the version number of the HDMI standard. In the example shown in FIG. 10, the Version is “1”.

In addition, Length is arranged in the lower five bits of byte 2 of the VSIF data, and the Length represents the size (number of bytes) of the VSIF payload (the portion after IEEE OUI). In the example shown in FIG. 10, Length is “27”.

In addition, Checksum is arranged in byte 3 of the VSIF data, and the Checksum represents the checksum of the entire VSIF data (byte 0 to byte 30 shown in FIG. 10).

In addition, IEEE OUI is arranged in byte 4 to byte 6 of the VSIF data, and the IEEE OUI represents a 3-byte number (OUI issued by IEEE) to identify the vendor of the VSIF. In the example shown in FIG. 10, the IEEE OUI is “00:00:3D”.

In addition, Data Type is arranged in byte 7 and byte 8 of the VSIF data, and the Data Type is a number (16-bit integer) representing the type of data arranged thereafter byte 9. In the example shown in FIG. 10, the Data Type is “0x0002”, which represents the DTL of the source digital twin.

In addition, the DTL of the source digital twin is arranged (inserted) thereafter byte 9 of the VSIF data. The DTL of the source digital twin is configured by the IP address (4 bytes), the port number (2 bytes), and the UUID (16 bytes).

Returning again to FIG. 9, the source device 11 transmits the above VSIF data to the sink device 12 via the HDMI cable 13 (step S26). In this case, the VSIF data is inserted into a blanking interval set in the video data transmitted from the source device 11 to the sink device 12 via the HDMI cable 13 and transmitted to the sink device 12. Note that the blanking interval is a gap area between the frames (video frames) that construct the video data.

The sink device 12 receives the VSIF data transmitted from the source device 11. The sink device 12 extracts the DTL of the source digital twin from the received VSIF data and transmits the DTL to the server device 22 for a sink (step S27).

The server device 22 for a sink receives the DTL of the source digital twin transmitted from the sink device 12 and establishes a connection with the server device 21 for a source based on the IP address and the port number that configures the received DTL of the source digital twin (step S28). Thereby, the server device 22 for a sink can capture that the sink device 12 and the source device 11 to which the UUID that configures the DTL of the source digital twin is assigned (that is, the source device 11 identified by the source device ID corresponding to the UUID) are connected via the HDMI cable 13.

As described above, in the first modified example of the present embodiment, the source device 11 transmits a source device ID (first identification information) for identifying the source device 11 to the server device 21 for a source (first server device) that constructs the digital twin of the source device 11, receives the DTL (first connection information) of the source digital twin that is created in the server device 21 for a source based on the source device ID from the server device 21 for a source, and transmits it to the sink device 12 via the HDMI cable 13. In addition, in the first modified example of the present embodiment, the sink device 12 transmits the DTL of the source digital twin transmitted from the source device 11 to the server device 22 for a sink (second server device) that constructs the digital twin of the sink device 12. In this manner, the DTL transmitted from the sink device 12 to the server device 22 for a sink is used to establish a connection between the server device 21 for a source and the server device 22 for a sink.

As described above, in the present embodiment, the digital twin of the video transmission system 1 constructed by establishing a connection between the server device 21 for a source and the server device 22 for a sink can be used to improve user convenience as described using FIG. 6. However, the same working effect as the present embodiment can also be achieved for the first modified example of the present embodiment.

Note that, in the first modified example of the present embodiment, the DTL of the source digital link is inserted into the VSIF data having a VSIF compliant data structure and transmitted from the source device 11 to the sink device 12 via the HDMI cable 13. This VSIF data is also inserted into the blanking interval set in the video data and transmitted. That is, in the first modified example of the present embodiment, as in the present embodiment described above, focusing on the high extensibility of the VSDB/VSIF, the DTL of the source digital twin can be passed from the source device 11 to the sink device 12 by using the extension function of the VSDB/VSIF.

By the way, in the present embodiment and the first modified example of the present embodiment described above, by constructing the digital twin of the video transmission system 1, the operator of the customer support center of the source device 11 (or the sink device 12), for example, can capture the state of the source device 11 and the sink device 12 in real time and provide support relating to the use of the video transmission system 1. However, there are cases in which problems (defects) related to the use of the video transmission system 1 are, for example, in the HDMI cable 13 connecting the source device 11 and the sink device 12. In such cases, the configuration according to the present embodiment and the first modified example of the present embodiment described above cannot provide appropriate support.

That is, although the digital twin of the video transmission system 1 including the source device 11 and the sink device 12 is described as being constructed in the present embodiment and the first modified example of the present embodiment, in order to further improve user convenience, it is desirable to have a mechanism that enables the construction of a digital twin of the video transmission system 1 including the source device 11, the sink device 12, and the HDMI cable 13.

The following describes a configuration for constructing a digital twin of the video transmission system 1 including the source device 11, the sink device 12, and the HDMI cable 13 (hereinafter referred to as a second modified example of the present embodiment).

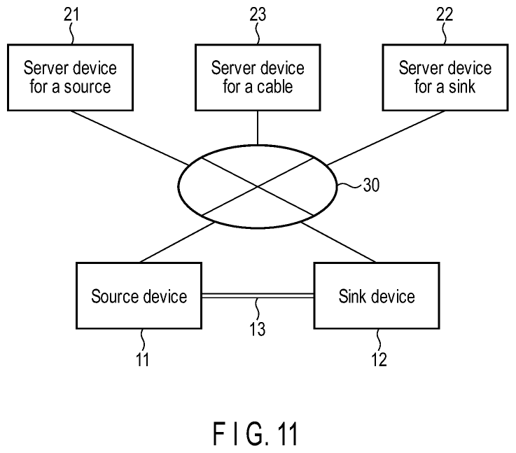

FIG. 11 shows an example of a configuration of a network system in the second modified example of the present embodiment. As shown in FIG. 11, in the second modified example of the present embodiment, in addition to the source device 11, the sink device 12, the server device 21 for a source, and the server device 22 for a sink shown in FIG. 1, a server device 23 for a cable is further connected to the network 30.

Note that, where the server device 21 for a source is a server device having a function of constructing a digital twin of the source device 11 and the server device 22 for a sink is a server device having a function of constructing a digital twin of the sink device 12, the server device 23 for a cable is a server device having a function of collecting data related to the HDMI cable 13 and constructing a digital twin of the HDMI cable 13 based on the data.

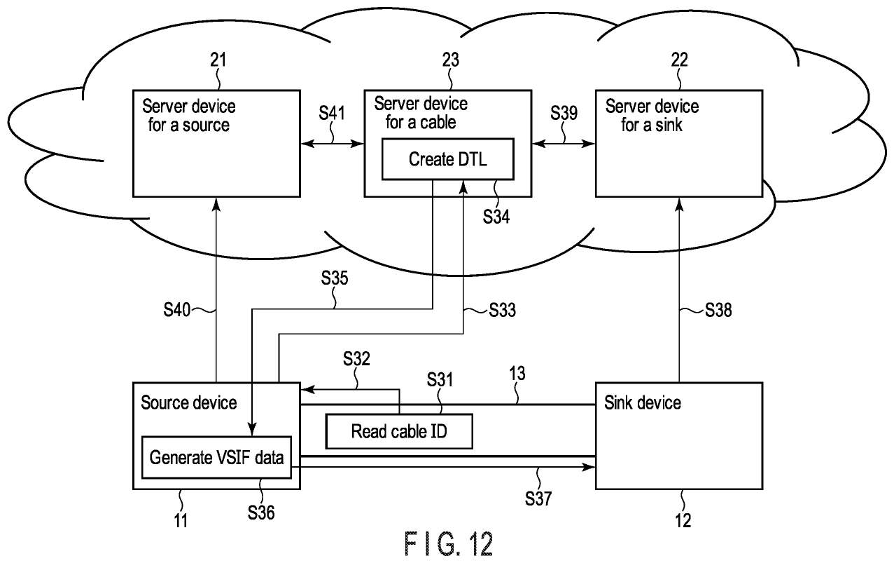

In the following, with reference to FIG. 12, a specific operation example of the video transmission system 1, the server device 21 for a source, the server device 22 for a sink, and the server device 23 for a cable according to the second modified example of the present embodiment will be described.

Here, (cable data including) a cable ID for identifying the HDMI cable 13 is written in the memory 131 (e.g., ROM) provided in the HDMI cable 13. Note that the cable ID should be written in the memory 131 at the time of shipment of the HDMI cable 13.

In the second modified example of the present embodiment, this cable ID is considered to be used to create connection information (DTL), but it is not realistic to give the HDMI cable 13 itself a function to execute communication via the network 30 such as the Internet (communication function). Therefore, in the second modified example of the present embodiment, the source device 11 executes communication as a proxy for the HDMI cable 13.

In this case, the cable ID is read from the memory 131 included in the HDMI cable 13 (step S31). Note that the cable ID read from the memory 131 includes a vendor ID, a product model number, and a serial number of the HDMI cable 13 as described above.

Next, the cable ID read from the memory 131 is transferred (transmitted) from the HDMI cable 13 to the source device 11 (step S32). This transfer of the cable ID is considered to be performed according to a status & control data channel (SCDC), which is an alternative protocol for DDC compliant with HDMI 2.1a, for example.

The source device 11 transmits the cable ID transferred from the HDMI cable 13 to the server device 23 for a cable (step S34).

The server device 23 for a cable uses the cable ID transmitted from the source device 11 to create a DTL to identify the server device 23 for a cable (i.e., a digital twin of the HDMI cable 13) (step S34). This DTL (hereinafter referred to as the DTL of the cable digital twin) corresponds to the connection information with respect to the server device 23 for a cable.

Note that the DTL of the cable digital twin is the same as the DTL of the sink digital twin described above, except that the cable ID is used instead of the sink device ID. Therefore, a detailed description of the DTL is omitted here. Note that, in order to create the DTL of the cable digital twin, the server device 23 for a cable is considered to prepare in advance a table that maintains the correspondence between the cable ID and the UUID assigned to the HDMI cable 13.

Next, the source device 11 receives the DTL of the cable digital twin transmitted from the server device 23 for a cable and generates VSIF data by adding (inserting) the DTL to the VSIF compliant data structure used in transmitting control information from the source device 11 to the sink device 12 as described above (step S36). Note that, since the data structure of the VSIF data is as described above in the first modified example of the present embodiment (FIG. 10), a detailed explanation is omitted here.

The source device 11 transmits the VSIF data to the sink device 12 via the HDMI cable 13 (step S37). In this case, the VSIF data is inserted into the blanking interval set in the video data and transmitted to the sink device 12.

The sink device 12 receives the VSIF data transmitted from the source device 11. The sink device 12 extracts the DTL of the cable digital twin from the received VSIF data and transmits the DTL to the server device 22 for a sink (step S38).

The server device 22 for a sink receives the DTL of the cable digital twin transmitted from the sink device 12 and establishes a connection with the server device 23 for a cable based on an IP address and a port number that configures the received DTL of the cable digital twin (step S39). Thereby, the server device 22 for a sink can capture that the sink device 12 is connected to the source device 11 via the HDMI cable 13 to which the UUID that configures the DTL of the cable digital twin is assigned (that is, the HDMI cable 13 identified by the cable ID corresponding to the UUID).

Meanwhile, the source device 11 transmits the received DTL of the cable digital twin to the server device 21 for a source (step S40).

The server device 21 for a source receives the DTL of the cable digital twin transmitted from the source device 11 and establishes a connection with the server device 23 for a cable based on the IP address and the port number configuring the received DTL of the cable digital twin (step S41). Thereby, the server device 21 for a source can capture that the source device 11 is connected to the sink device 12 via the HDMI cable 13 to which the UUID that configures the DTL of the cable digital twin is assigned (that is, the HDMI cable 13 identified by the cable ID corresponding to the UUID).

Note that, in FIG. 12, processing is described as being executed in the order of steps S31 to S41. However, since processing in steps S36 to S39 is for establishing a connection between the server device 22 for a sink and the server device 23 for a cable, and processing in steps S40 and S41 is for establishing a connection between the server device 21 for a source and the server device 23 for a cable, the order in which the processing in steps S36 to S39 is executed and the order in which the processing in steps S41 and S42 is executed may be interchanged, or the processing in steps S36 to S39 and the processing in steps S41 and S42 may be executed in parallel.

In a case where the processing described in the second modified example of the present embodiment is further executed in a state where the connection between the server device 21 for a source and the server device 22 for a sink is established by executing the processing described in the present embodiment or the processing described in the first modified example of the present embodiment as described above, the server device 21 for a source, the server device 22 for a sink, and the server device 23 for a cable can operate in cooperation with each other. In this case, by sharing the data collected from the source device 11, the data collected from the sink device 12, and the data collected from the HDMI cable 13 with the server device 21 for a source, the server device 22 for a sink, and the server device 23 for a cable, the data can be used to construct a digital twin of the entire video transmission system 1 including the source device 11, the sink device 12, and the HDMI cable 13 (a digital twin combining the digital twin of the source device 11, the digital twin of the sink device 12, and the digital twin of the HDMI cable 13).

According to such a digital twin, even in a case where there is no problem in using the source device 11 and the sink device 12, the operator of the customer support center of the source device 11 can capture the state of the HDMI cable 13 (e.g., the direction of the HDMI cable 13 connecting the source device 11 and the sink device 12 is reversed) in real time and support the user of the HDMI cable 13.

That is, in the second modified example of the present embodiment, since the state of the video transmission system 1 can be captured in more detail than in the present embodiment and the first modified example of the present embodiment described above, a service that further improves user convenience can be provided.

Note that, in the second modified example of the present embodiment, the server device 23 for a cable is described as collecting data relating to the HDMI cable 13 (i.e., having a function of constructing a digital twin of the HDMI cable 13); however, the HDMI cable 13 itself has no communication function as described above. In this case, the data relating to the HDMI cable 13 may be collected via the source device 11 or the sink device 12, or by adding other functions to the HDMI cable 13.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video transmission system comprising a source device transmitting video data, a sink device receiving the video data, and an HDMI cable connecting the source device and the sink device, wherein
the sink device comprises:
a first transmitter transmitting first identification information for identifying the sink device to a first server device constructing a digital twin of the sink device;
a first receiver receiving first connection information with respect to the first server device created by the first server device based on the first identification information; and
a second transmitter transmitting the received first connection information to the source device via the HDMI cable,
the source device comprises a third transmitter transmitting the first connection information transmitted by the second transmitter to a second server device constructing a digital twin of the source device, and
the first connection information transmitted by the third transmitter is used to establish a connection between the first server device and the second server device.

2. The video transmission system of claim 1, wherein the first connection information is inserted into VSDB data having a vendor-specific data block (VSDB) compliant data structure and transmitted to the source device.

3. The video transmission system of claim 2, wherein the VSDB data is transmitted according to a display data channel (DDC).

4. The video transmission system of claim 1, wherein
the source device further comprises:
a fourth transmitter receiving second identification information for identifying the HDMI cable from the HDMI cable, and transmitting the information to a third server device constructing a digital twin of the HDMI cable;
a second receiver receiving second connection information with respect to the third server device created by the third server device based on the second identification information; and
a fifth transmitter transmitting the received second connection information to the sink device via the HDMI cable,
the third transmitter transmits the received second connection information to the second server device,
the first transmitter transmits the second connection information transmitted by the fifth transmitter to the first server device, and
the second connection information is used to establish a connection between the first and second server devices and the third server device.

5. The video transmission system of claim 4, wherein the second connection information is inserted into VSIF data having a vendor-specific InfoFrame (VSIF) compliant data structure and transmitted to the sink device.

6. The video transmission system of claim 5, wherein the VSIF data is inserted into a blanking interval set in the video data and transmitted to the sink device.

7. A video transmission system comprising a source device transmitting video data, a sink device receiving the video data, and an HDMI cable connecting the source device and the sink device, wherein
the source device comprises:
a first transmitter transmitting first identification information for identifying the source device to a first server device constructing a digital twin of the source device;
a first receiver receiving first connection information with respect to the first server device created by the first server device based on the first identification information; and
a second transmitter transmitting the received first connection information to the sink device via the HDMI cable,
the sink device comprises a third transmitter transmitting the first connection information transmitted by the second transmitter to a second server device constructing a digital twin of the sink device, and
the first connection information transmitted by the third transmitter is used to establish a connection between the first server device and the second server device.

8. The video transmission system of claim 7, wherein the first connection information is inserted into first VSIF data having a VSIF compliant data structure and transmitted to the sink device.

9. The video transmission system of claim 8, wherein the first VSIF data is inserted into a blanking interval set in the video data and transmitted to the sink device.

10. The video transmission system of claim 7, wherein
the source device further comprises:
a fourth transmitter receiving second identification information for identifying the HDMI cable from the HDMI cable, and transmitting the second identification information to a third server device constructing a digital twin of the HDMI cable; and
a second receiver receiving second connection information with respect to the third server device created by the third server device based on the second identification information,
the first transmitter transmits the received second connection information to the first server device,
the second transmitter transmits the received second connection information to the sink device via the HDMI cable,
the third transmitter transmits the second connection information transmitted by the second transmitter to the second server device, and
the second connection information is used to establish a connection between the first and second server devices and the third server device.

11. The video transmission system of claim 10, wherein the second connection information is inserted into second VSIF data having a VSIF compliant data structure and transmitted to the sink device.

12. The video transmission system of claim 11, wherein the second VSIF data is inserted into a blanking interval set in the video data and transmitted to the sink device.

13. A method executed by a video transmission system comprising a source device transmitting video data, a sink device receiving the video data, and an HDMI cable connecting the source device and the sink device, the method comprising:
transmitting, by the sink device, first identification information for identifying the sink device to a first server device constructing a digital twin of the sink device;
receiving, by the sink device, first connection information with respect to the first server device created by the first server device based on the first identification information;
transmitting, by the sink device, the received first connection information to the source device via the HDMI cable; and
transmitting, by the source device, the first connection information transmitted from the sink device to a second server device constructing a digital twin of the source device, wherein
the first connection information transmitted from the source device is used to establish a connection between the first server device and the second server device.

14. A method executed by a video transmission system comprising a source device transmitting video data, a sink device receiving the video data, and an HDMI cable connecting the source device and the sink device, the method comprising:
transmitting, by source device, first identification information for identifying the source device to a first server device constructing a digital twin of the source device;
receiving, by the source device, first connection information with respect to the first server device created by the first server device based on the first identification information;
transmitting, by the source device, the received first connection information to the sink device via the HDMI cable; and
transmitting, by the sink device, the first connection information transmitted from the source device to a second server device constructing a digital twin of the sink device, wherein
the first connection information transmitted from the sink device is used to establish a connection between the first server device and the second server device.
